(19) United States
(12) Patent Application Publication
(10) Pub. No.: US 2022/0027844 A1
(43) Pub. Date: Jan. 27, 2022

(54) DEVICE, METHOD AND SYSTEM FOR IMPLEMENTING HARDWARE-BASED PACKAGE RECEIPT PROCEDURES

(71) Applicant: MOTOROLA SOLUTIONS, INC., Chicago, IL (US)

(72) Inventors: Trent J. MILLER, Chicago, IL (US); Daniel S. GRIESMANN, Chicago, IL (US); Lin LIN, Chicago, IL (US); Hao ZENG, Long Grove, IL (US); Charles SPENGLER, Hoffman Estates, IL (US)

(21) Appl. No.: 16/939,662

(22) Filed: Jul. 27, 2020

(51) Int. Cl. G06Q 10/08

(52) U.S. Cl. CPC G06Q 10/0833

(57) ABSTRACT

A device, method and system for implementing hardware-based package receipt procedures is provided. A device is in communication with a camera device configured to image a region adjacent a controlled access point. The device determines, using images from the camera device, that a delivery person has arrived at the controlled access point with a package. The device authenticates the package by comparing information extracted from the images with package order information indicative of one or more of the package and an intended recipient of the package. In response to authenticating the package, the devices implements one or more package receipt procedures to control receipt of the package, the one or more package receipt procedures implemented using one or more of: the camera device; a communication device located at the controlled access point; and an access control mechanism of the controlled access point.

### BACKGROUND OF THE INVENTION

When a package is delivered to controlled access points, such as doors, gates, and the like, of an enterprise, generally a mailroom enterprise receiver, who is not the ultimate recipient of the package, signs for and receives the package, and later arranges for the package to be delivered to the ultimate recipient.

### BRIEF DESCRIPTION OF THE SEVERAL VIEWS OF THE DRAWINGS

The accompanying figures, where like reference numerals refer to identical or functionally similar components throughout the separate views, together with the detailed description below, are incorporated in and form part of the specification, and serve to further illustrate embodiments of concepts that include the claimed invention, and explain various principles and advantages of those embodiments.

FIG. 1 is a system for implementing hardware-based package receipt procedures, in accordance with some examples.

FIG. 2 is a device diagram showing a device structure of a device for implementing hardware-based package receipt procedures, in accordance with some examples.

FIG. 3 is a flowchart of a method for implementing hardware-based package receipt procedures, in accordance with some examples.

FIG. 4 depicts a portion of a method for implementing hardware-based package receipt procedures occurring at the system of FIG. 2, in accordance with some example, in accordance with some examples.

FIG. 5 depicts another portion of the method for implementing hardware-based package receipt procedures occurring at the system of FIG. 2, in accordance with some example, in accordance with some examples.

Skilled artisans will appreciate that components in the figures are illustrated for simplicity and clarity and have not necessarily been drawn to scale. For example, the dimensions of some of the components in the figures may be exaggerated relative to other components to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

When a package is delivered to controlled access points, such as doors, gates, and the like, of an enterprise, generally a mailroom enterprise receiver, who is not the ultimate and/or intended recipient of the package, signs for and receives the package, and later arranges for the package to be delivered to the intended recipient. Arrangements are made for the mailroom enterprise receiver to deliver the package to the intended recipient. Such a process is generally inefficient and/or may be inaccurate (e.g. with many people involved in the delivery process, the package may or may not make it to the intended recipient) and/or adds complexity to a chain-of-custody of the package.

Hence, according to the present specification, a computing device is provided that has access to package order information and further has access to images from a camera device at a controlled access point to which packages are delivered. The computing device authenticates a package delivered to the controlled access point by comparing the package order information with information extracted from the images. For example, the images may include information from a label of the package, such as address information, a name of the intended recipient, an order number and the like, which can be compared to the package order information to authenticate the package. However, the images may include the delivery person, their truck, their uniform, and the like, which may be used to determine the entity from which the package was ordered, as indicated by the package order information, which may also be used to authenticate the package. Alternatively, an estimated delivery time may be determined from the package order information and compared to the actual delivery time of the package, as determined by identifying the package in the images, which may also be used to authenticate the package. Alternatively, an estimated size and/or shape of the package, determined from the package order information, may be compared with a respective estimated size and/or shape of the package determined from the images, which may also be used to authenticate the package. However, any suitable authentication procedure implemented by comparing the package order information with the images is within the scope of the present specification. Regardless of how the package is authenticated, in response to authenticating the package, the computing device, implements one or more hardware-based package receipt procedures to control receipt of the package. For example, the camera device and/or a communication device at the controlled access point may be used to communicate with a respective communication device of the intended recipient so that the intended recipient may communicate with the package delivery person and arrange to receive the package. Alternatively, the controlled access point may be unlocked and/or opened, via an access control mechanism, and the like, such that the package delivery person may pass therethrough and deliver the package to a mailroom and/or package drop-off area, and the like. However, any suitable hardware-based package receipt procedure (e.g. implemented using the camera device and/or a communication device located at the controlled access point and/or an access control mechanism of the controlled access point) is within the scope of the present specification.

An aspect of the present specification provides a method comprising: determining, at a computing device, using images from a camera device communicatively coupled to the computing device and configured to image a region adjacent a controlled access point, that a delivery person has arrived at the controlled access point with a package; authenticating, at the computing device, the package by comparing information extracted from the images with package order information indicative of one or more of the package and an intended recipient of the package; and in response to authenticating the package, implementing, at the computing device, one or more package receipt procedures to control receipt of the package, the one or more package receipt procedures implemented using one or more of: the camera device; a communication device located at the controlled access point; and an access control mechanism of the controlled access point.

Another aspect of the present specification provides a device comprising: a communication unit configured to communicate with a camera device configured to image a region adjacent a controlled access point; and a controller communicatively coupled to the camera device via the communication unit, the controller configured to: determine, using images from the camera device, that a delivery person has arrived at the controlled access point with a package; authenticate the package by comparing information extracted from the images with package order information indicative of one or more of the package and an intended recipient of the package; and in response to authenticating the package, implement one or more package receipt procedures to control receipt of the package, the one or more package receipt procedures implemented using one or more of: the camera device; a communication device located at the controlled access point; and an access control mechanism of the controlled access point.

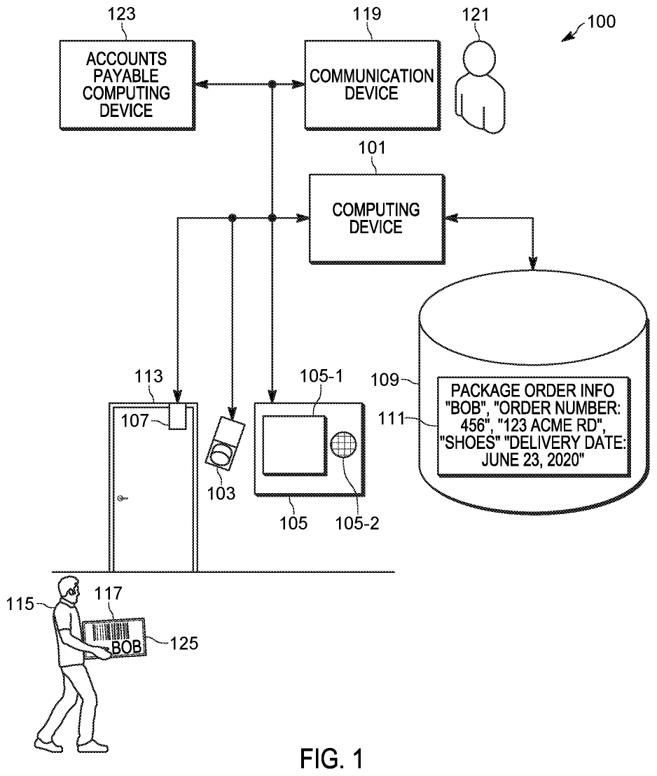

Attention is directed to FIG. 1, which depicts an example system 100 for implementing hardware-based package receipt procedures. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks.

The system 100 comprises a computing device 101 (e.g. hereafter referred to interchangeably as the device 101) which is in communication with a camera device 103, a communication device 105 (e.g. comprising a display screen 105-1 and a speaker/microphone 105-2), an access control mechanism 107, and a memory 109 storing package order information 111. As depicted, the camera device 103 is configured to image a region adjacent a controlled access point 113; in particular, the camera device 103 is mounted and/or located adjacent the controlled access point 113. Furthermore, the communication device 105 is also mounted and/or located adjacent the controlled access point 113.

As depicted, a package delivery person 115 has approached the controlled access point 113 to deliver a package 117 associated with the package order information 111, as described in more detail below.

As depicted, the device 101 is further in communication with a communication device 119 of an intended recipient 121 of the package 117 and an accounts payable computing device 123.

As depicted, the device 101, and the combined camera device 103 and communication device 105 are separate from each other, and the device 101 may be remote from the controlled access point 113 (e.g. the device 101 may be cloud-based). However, in other examples, the device 101 may be combined with the one or more of the camera device 103 and the communication device 105. Similarly, while as depicted, the camera device 103 is separate from the communication device 105, in other examples the camera device 103 and the communication device 105 may be combined.

Similarly, while the memory 109 is depicted as being separate from the device 101, the device 101 and the memory 109 may be combined. As depicted, the memory 109 is in form of a database, however, the memory 109 may be provided in any suitable format, and/or may be combined with a memory of the device 101. Put another way, the memory 109 may be located at the depicted location (e.g. “on-premises”) with the device 101; and/or the device 101 and/or the memory 109 may be cloud-based and the memory 109 may be accessible to the device 101 via one or more intervening networks.

As depicted, the communication device 105 and the camera device 103 may be combined in a single device and mounted adjacent the controlled access point 113. While as depicted the communication device 105 and the camera device 103 are mounted beside the controlled access point 113, the term “adjacent” may be understood to mean any position relative to the controlled access point 113 which may enable the camera device 103 to image the delivery person 115 (and/or the package 117), as the delivery person 115 approaches the controlled access point 113. Put another way, the term “adjacent” may be understood to mean any position relative to the controlled access point 113 in which a field-of view of the camera device 103 is positioned to image the delivery person 115 (and/or the package 117), as the delivery person 115 approaches the controlled access point 113. Hence, for example, the camera device 103 and/or the communication device 105 being mounted adjacent the controlled access point 113 may include, but is not limited to, the camera device 103 and/or the communication device 105 being mounted on a wall and/or surface beside the controlled access point 113, on a ceiling, and the like, above the controlled access point 113, on a wall and/or surface across from the controlled access point 113, and/or any other suitable wall and/or surface and/or ceiling.

The camera device 103 may comprise one or more camera devices including, but not limited to, one or more digital cameras, one or more video cameras, and the like, that acquires electronic images periodically and/or in response to motion and/or objects being detected at the controlled access point 113 (e.g. via a motion sensor and/or an object sensor, and the like, not depicted), and/or on demand, and/or in any other suitable manner. When the camera device 103 includes more than one camera device and/or a plurality of camera devices, the plurality of camera devices may be mounted at different positions adjacent the controlled access point 113 to image a collective field-of-view and/or a larger field of view than a single camera device.

The camera device 103 may further acquire two-dimensional electronic images and/or three-dimensional electronic images (e.g. the camera device 103 may comprise a two-dimensional camera and/or three-dimensional camera). The camera device 103 may acquire the electronic images at visual wavelengths (e.g. wavelengths viewable by a human visual system) and/or non-visual wavelengths (e.g. infrared wavelengths and/or ultra-violet wavelengths). In some examples the camera device 103 may include, and/or be provided with, other types of sensor devices including, but not limited to a thermograph device, a LIDAR device, a radar device, an X-Ray device, an ultrasound device, and the like; sensor data from such sensors may be used in combination with the images acquired by the camera device 103 to authenticate a package.

The communication device 105, as depicted, comprises the display screen 105-1, and the speaker/microphone 105-2, and may be provided in the form of a wall mounted intercom, and the like, which may, or may not, be combined with the camera device 103. However, the communication device 105 may include any suitable combination of one or more communication devices provided in any suitable format.

The controlled access point 113 may generally comprise a door, a double door, a gate, a portal, an entrance, a turnstile, an exit, and the like through which passage is electronically controlled via the access control mechanism 107. The controlled access point 113 may be located at an entrance and/or an exit to a building and/or room and/or hallway, and the like, through which passage is electronically controlled. While the controlled access point 113 is depicted as a physical barrier mechanism, the controlled access point 113 may additionally and/or alternatively comprise any suitable non-physical barrier mechanism through which passage is controlled, for example, using electromagnetic fields, disorienting holograms, or another non-visible type of barrier mechanism that may be used prevent passage therethrough. In yet further examples, passage through the controlled access point 113 may be via a screen (such as the display screen 105-1) and/or a light indicating and/or instructing whether a person may enter or not, for example via rendering and/or display of text and/or graphics (e.g. “Go” vs. “Stop”) or color (e.g. green vs. red). In the depicted examples, the controlled access point 113 comprises a single physical door, that may be electronically locked, unlocked, opened and/or closed; in particular, when the door is unlocked and/or opened, a mover may pass therethrough.

As such, the access control mechanism 107 may comprise any suitable access control mechanism including, but not limited to, an electronic lock, an electronic door opening/closing mechanism, an electronic gate opening/closing mechanism, and/or any combination of devices that provided the aforementioned non-visible types of barrier mechanisms and/or a combination of devices that provide the aforementioned text and/or graphics and/or color. Regardless, it is understood that the controlled access point 113 may initially be in a state that prevents (e.g. physically and/or via instruction) access therethrough, for example by the delivery person 115.

The device 101 generally receives images from the camera device 103, which, when the delivery person 115 and/or the package 117, are located in the field-of-view of the camera device 103, include at least a portion of the delivery person 115 and/or the package 117. Alternatively, the images from the camera device 103 may include a uniform, hat, pin, and/or badge, and the like, worn by the delivery person 115 and which may include a logo, and/or other identifier, of an entity for which the delivery person 115 works (e.g. delivering packages); in examples that include a badge, and the like, the badge may include a name and/or photo of the delivery person 115 and/or a bar code or Quick Response (QR) code, and the like, identifying the delivery person 115. Alternatively, the images from the camera device 103 may include a vehicle that the delivery person 115 used to arrive at the controlled access point 113, and which may include a logo, and/or other identifier, of the entity for which the delivery person 115 works. Indeed, the images from the camera device 103 may include any suitable identifier of the delivery person 115 and/or an entity for which the delivery person 115 works.

Alternatively, the images from the camera device 103 may include a printed label 125 on the package 117, and the like, which may include (e.g. as depicted) a bar code, and the like, (e.g. any suitable graphic with data encoded therein including, but not limited to, a QR code, a hologram, and the like), a name of the intended recipient 121 (e.g. as depicted, in a simple example, “Bob”, and the like, though a first and last name may be provided), an address of the intended recipient 121 (e.g. a mailing address and/or geographic address of the building at which the controlled access point 113 is located), an order number (and/or a purchase order number), an identifier (such as a logo, a graphic, a textual identifier (e.g. “Shoes”) and the like, of the ordered item in the package 117, package shipping company information (e.g. an identifier of the entity from which the package 117 was ordered and/or an identifier of an entity delivering the package 117 and/or for which the delivery person 115 works) and the like. The bar code, and the like, may have any suitable information encoded therein including, but not limited to, any of the above described information that may (or may not) also be printed on the label 125. However, the label 125 may include any suitable information in any suitable format. In some examples, data obtained from the package 117 (e.g. from images of the package 117) may include, but is not limited to, secure and/or encrypted data (e.g. printed on the label 125 and/or encoded into a graphic and the like); in these examples, the package order information 111 may include, a decryption key (e.g. as received from the entity from which the package was ordered) and the decryption key may be used to decrypt the secure and/or encrypted data.

As depicted, the package order information 111 may include information similar to the label 125. For example, as depicted, the package order information 111 may include, but is not limited to, a name of the intended recipient 121, an order number (e.g. “456”), an address of the intended recipient 121 (e.g. “123 Acme Rd”), an identifier of an ordered item (e.g. a logo, a graphic, a textual identifier (e.g. “Shoes”), and the like, and which may be contained in the package 117), and a delivery date (e.g. “Jun. 23, 2020”) and/or (not depicted), a date that the item was ordered. In some examples, the package order information 111 may include a size (e.g. dimensions of the package 117). In some examples, the package order information 111 may include an identifier of the delivery person 115 (e.g. a name and/or image thereof, and/or information encoded into a barcode, and the like, worn by the delivery person 115 at a badge, and the like), for example as supplied when ordering the item and the like) and/or an identifier of an entity for which the delivery person 115 works and/or an identifier of an entity from which the package 117 was ordered. In yet further examples, the package order information 111 may include a facial recognition template info and/or other biometric enrollment data which assists in identifying the delivery person 115.

The package order information 111 may be generated by any suitable device of the system 100 when the item associated with the package order information 111, (the item to be shipped in the package 117), is ordered, and may be provided and/or generated by a purchasing department device (not depicted) of the system 100 and/or via the respective communication device 119 and/or another computing device operated by the intended recipient 121 (e.g. when ordering the item), and/or any other suitable device. In one particular example, an item in the package 117 may be ordered by a purchasing department via a purchasing department device and the associated package order information 111 may be forwarded to the computing device 101 (and/or the memory 109) by the purchasing department device (e.g. via one or more wired and/or wireless electronic networks), and upon receipt may act as an instruction to the computing device 101 to implement a hardware-based package receipt procedure when the package 117 arrives at the controlled access point 113; in these examples, the accounts payable computing device 123 may be used to pay for, and/or track receipt of the package 117.

In another particular example, the intended recipient 121 may order an item via a commercial website, and the like, and the commercial website may provide the intended recipient 121 with the package order information 111 (e.g. via a message to the respective communication device 119 via one or more wired and/or wireless electronic networks); the intended recipient 121 may operate the respective communication device 119 to forward the package order information 111 to the computing device 101 (and/or the memory 109), which may act as an instruction to the computing device 101 to implement a hardware-based package receipt procedure when the package 117 arrives at the controlled access point 113.

While the memory 109 is depicted as storing only one set of package order information 111, the memory 109 may store more than one set of package order information (e.g. for a plurality of items being ordered by various recipients associated with a same enterprise, building, and/or receiving office), for example in a database format.

As will be described in more detail hereafter, as the delivery person 115 approaches the controlled access point 113, the device 101 may receive images from the camera device 103 and extract information therefrom, such as information from the label 125, as described above, an estimated size and/or shape of the package 117, a face and/or name of the delivery person 115 (and/or any other suitable information identifying the delivery person 115), a logo, and/or other identifier, of the entity for which the delivery person 115 works, and the like.

Furthermore, as has been previously described, the device 101 generally has access to the package order information 111 and may retrieve and/or receive the package order information 111 from the memory 109, for example when the device 101 does not already store the package order information 111.

In general, the device 101 may compare information extracted from the images from the camera device 103 with the package order information 111 to authenticate the package 117, as described in more detail below. In a simple example, information extracted from the images from the camera device 103 may include a name of the intended recipient 121 which may match a name of the intended recipient 121 in the package order information 111. It is understood that, when the package 117 and/or the label 125 includes a barcode, and the like, the computing device 101 is further generally configured to decode the information encoded in the barcode, and the like; in some examples, the barcode, and the like, may include a link, encoded therein, to a database where such information (a name of the intended recipient, etc.) may be retrieved. In a more complex example, an estimated size and/or shape of the package 117 may be determined from the images, which may match a respective estimated size and/or shape of the package 117 determined from the package order information 111 (e.g. a package containing “Shoes” may be estimated to be of a particular size and/or shape and/or the package order information 111 may include a size of the package 117).

It is understood that the term “match” as used herein may include, but is not limited to, matches that are not exact but rather may meet a threshold confidence level, and the like. In particular, the device 101 may compare information extracted from the images from the camera device 103 with the package order information 111 and assign a confidence level to the match, for example using an object recognition engine, an optical character recognition algorithm, machine learning algorithms, and the like, and determine that the information extracted from the images from the camera device 103 matches the package order information 111 when the confidence level exceeds a threshold confidence level, and the like. The threshold confidence level may be set to any suitable value such as “70%”, “80%”, “90%” and the like. Such a process may also be referred to as threshold matching, and the like.

Such a comparison may be used to authenticate the package 117, in response to which the device 101 implements one or more hardware-based package receipt procedures to control receipt of the package 117, using, for example, one or more of camera device 103, the communication device 105, the access control mechanism 107, and the like. In one example, the computing device 101 may control the communication device 105 and/or the camera device 103 to establish a two-way media session with the respective communication device 119 of the intended recipient 121 which may include, but is not limited to, any suitable combination of real-time audio, real-time video, sensor data (e.g. from sensor devices provided with the camera device 103), metadata (e.g. a time, and/or information from the package order information 111 and/or information from the images from the camera device 103, and the like, used to authenticate the package 117), and the like .

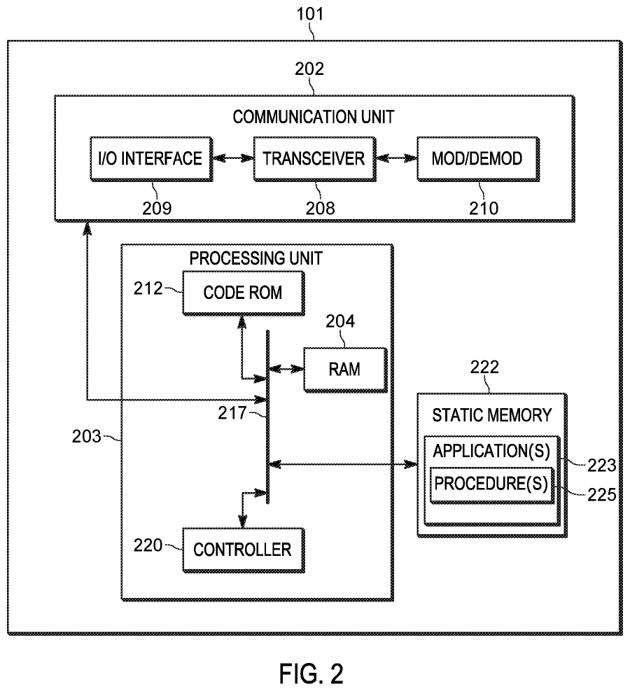

Attention is next directed to FIG. 2, which depicts a schematic block diagram of an example of the device 101. In general, the device 101 may comprise any suitable computing device and/or cloud device and/or a discrete device mountable to a surface adjacent an access point (e.g. the controlled access point 113). In examples where the device 101 comprises a cloud device, functionality of the device 101 may be provides at one or more cloud-based devices and the device 101 may communicate with the camera device 103, the communication devices 105 and/or the access control mechanism 107, via one or more intervening communication networks (e.g. the Internet, etc.); in such examples, the camera device 103, the communication devices 105 and/or the access control mechanism 107 may comprise Internet-of-Things (IoT) devices.

As depicted, the device 101 comprises: a communication unit 202, a processing unit 203, a Random-Access Memory (RAM) 204, one or more wireless transceivers 208 (which may be optional), one or more wired and/or wireless input/output (I/O) interfaces 209, a combined modulator/demodulator 210, a code Read Only Memory (ROM) 212, a common data and address bus 217, a controller 220, and a static memory 222 storing at least one application 223 that includes instructions for implementing one or more hardware-based package receipt procedures 225. Hereafter, the at least one application 223 will be interchangeably referred to as the application 223 (and which is understood to include the instructions for implementing one or more hardware-based package receipt procedures 225).

While not depicted, the device 101 may include one or more of an input device and a display screen and the like such that an administrator user, and the like, may interact with the device 101. When the device 101 is combined with the communication device 105, the device 101 includes the display screen 105-1, the speaker/microphone 105-2, and the like. When the device 101 is combined with the camera device 103, the device 101 includes the camera device 103.

As shown in FIG. 2, the device 101 includes the communication unit 202 communicatively coupled to the common data and address bus 217 of the processing unit 203.

The processing unit 203 may include the code Read Only Memory (ROM) 212 coupled to the common data and address bus 217 for storing data for initializing system components. The processing unit 203 may further include the controller 220 coupled, by the common data and address bus 217, to the Random-Access Memory 204 and the static memory 222.

The communication unit 202 may include one or more wired and/or wireless input/output (I/O) interfaces 209 that are configurable to communicate with other components of the system 100. For example, the communication unit 202 may include one or more transceivers 208 and/or wireless transceivers for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g. a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication unit 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 210.

The controller 220 may include ports (e.g. hardware ports) for coupling to other suitable hardware components of the system 100.

The controller 220 may include one or more logic circuits, one or more processors, one or more microprocessors, and/or the controller 220 may include one or more ASIC (application-specific integrated circuits) and one or more FPGA (field-programmable gate arrays), and/or another electronic device. In some examples, the controller 220 and/or the computing device 101 is not a generic controller and/or a generic device, but a device specifically configured to implement functionality for implementing hardware-based package receipt procedures. For example, in some examples, the computing device 101 and/or the controller 220 specifically comprises a computer executable engine configured to implement functionality for implementing hardware-based package receipt procedures.

The static memory 222 comprises a non-transitory machine readable medium that stores machine readable instructions to implement one or more programs or applications. Example machine readable media include a non-volatile storage unit (e.g. Erasable Electronic Programmable Read Only Memory (“EEPROM”), Flash Memory) and/or a volatile storage unit (e.g. random-access memory (“RAM”)). In the example of FIG. 2, programming instructions (e.g., machine readable instructions) that implement the functional teachings of the computing device 101 as described herein are maintained, persistently, at the memory 222 and used by the controller 220, which makes appropriate utilization of volatile storage during the execution of such programming instructions.

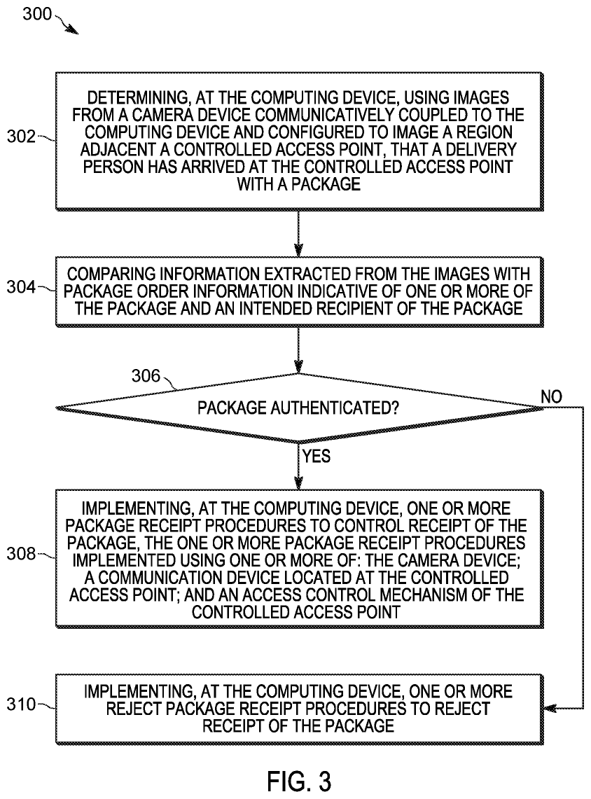

In particular, the memory 222 stores instructions corresponding to the at least one application 223 that, when executed by the controller 220, enables the controller 220 to implement functionality for implementing hardware-based package receipt procedures, but not limited to, the blocks of the method set forth in FIG. 3.

In illustrated examples, when the controller 220 executes the one or more applications 223, the controller 220 is enabled to: determine, using images from a camera device communicatively coupled to the computing device and configured to image a region adjacent a controlled access point, that a delivery person has arrived at the controlled access point with a package; authenticate the package by comparing information extracted from the images with package order information indicative of one or more of the package and an intended recipient of the package; and in response to authenticating the package, implement one or more package receipt procedures to control receipt of the package, the one or more package receipt procedures implemented using one or more of: the camera device; a communication device located at the controlled access point; and an access control mechanism of the controlled access point.

The application 223 may include programmatic algorithms, and the like, to implement functionality as described herein and which may include, but it not limited to, a programmatic object recognition engine.

Alternatively, and/or in addition to programmatic algorithms, the application 223 may include one or more machine learning algorithms to implement functionality as described herein. The one or more machine learning models and/or algorithms of the application 223 may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like, in some security environments. Any suitable machine learning algorithm and/or deep learning algorithm and/or neural network is within the scope of present examples.

In some examples, the machine learning algorithms may be configured to extract information from the images as described above using, for example, a machine learning based object recognition engine.

While details of the devices 119, 123 are not depicted, such devices 119, 123 may have a configuration similar to that of the device 101 as depicted in FIG. 2, but adapted for the respective functionality thereof. For example, the respective communication device 119 may comprise a mobile communication device (such as a cell phone, and the like) carried and/or operated by the intended recipient 121. The accounts payable computing device 123 may comprise an enterprise server, and the like, operated and/or used by employees of an accounts payable department.

Attention is now directed to FIG. 3, which depicts a flowchart representative of a method 300 for implementing hardware-based package receipt procedures. The operations of the method 300 of FIG. 3 correspond to machine readable instructions that are executed by the device 101, and specifically the controller 220 of the device 101. In the illustrated example, the instructions represented by the blocks of FIG. 3 are stored at the memory 222 for example, as the application 223. The method 300 of FIG. 3 is one way in which the controller 220 and/or the computing device 101 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

At a block 302, the controller 220 and/or the device 101, determines, using images from the camera device 103 (communicatively coupled to the computing device 101 and configured to image a region adjacent the controlled access point 113), that the delivery person 115 has arrived at the controlled access point 113 with the package 117.

For example, at the block 302 it is understood that the controller 220 and/or the device 101 may be receiving images from the camera device 103 and analyzing the images (e.g. via an object recognition engine) to determine when delivery persons and/or packages arrive at the controlled access point 113. In some examples, the controller 220 and/or the device 101 may use a face detection algorithm (e.g. which may comprise a module of the application 223), and the like, on the images from the camera device 103 to determine that a delivery person (and/or a person) has arrived at the controlled access point 113.

At a block 304, the controller 220 and/or the device 101 compares information extracted from the images with the package order information 111, the package order information 111 indicative of one or more of the package 117 and the intended recipient 121 of the package 117, for example to determine that the package 117 is authenticated, as described in more detail below (e.g. but which may include using threshold confidence level(s) to match, and/or threshold match, the package order information 111 with information extracted from the images, to determine that the package 117 is an expected package and can be delivered at this location).

It is furthermore understood that, at the block 302 and/or the block 304, the controller 220 and/or the device 101 may extract information from the images from the camera device 103, as described above, including, but not limited to, information from the label 125, a size and/or shape of the package 117, a delivery time of the package 117, an identifier of the delivery person 115, an identifier of an entity for which the delivery person 115 works, and the like. Indeed, information from the label 125 may be used to search the memory 109 for the package order information 111 (e.g. via a database lookup and the like).

At a block 306, the controller 220 and/or the device 101 determines whether the package 117 is authenticated based on the comparison at the block 304.

The controller 220 and/or the device 101 may authenticate the package 117, by comparing the package order information 111 with information extracted from the images using any suitable combination of comparisons, as next described.

In some examples, controller 220 and/or the device 101 may authenticate the package 117 by comparing a name of the intended recipient 121 from the package order information 111 with a respective name on the package 117 (e.g. at the label 125) as extracted from the images. When a match therebetween occurs (e.g. which may be determined using confidence levels and threshold confidence levels, as describe above), the controller 220 and/or the device 101 may determine that the package 117 is authenticated; otherwise the package 117 is not authenticated.

In some examples, controller 220 and/or the device 101 may authenticate the package 117 by comparing an estimated size of the package 117, determined from the package order information 111, with a size of the package 117 determined from the images. When a match therebetween occurs (e.g. which may be determined using confidence levels and threshold confidence levels, as describe above), the controller 220 and/or the device 101 may determine that the package 117 is authenticated; otherwise the package 117 is not authenticated.

In some examples, controller 220 and/or the device 101 may authenticate the package 117 by comparing a respective image of a predetermined delivery person 115 from the package order information 111 with a respective image of the delivery person 115 extracted from the images. When a match therebetween occurs (e.g. which may be determined using confidence levels and threshold confidence levels, as describe above), the controller 220 and/or the device 101 may determine that the package 117 is authenticated; otherwise the package 117 is not authenticated.

In some examples, controller 220 and/or the device 101 may authenticate the package 117 by comparing an identifier and/or logo, and the like, of a delivery service entity (e.g. an entity for which the delivery person 115 works) from the package order information 111 with a respective identifier extracted from the images, the respective identifier located at one or more of the package 117, a uniform of the delivery person 115 and a vehicle of the delivery person 115 located in the images. When a match therebetween occurs (e.g. which may be determined using confidence levels and threshold confidence levels, as describe above), the controller 220 and/or the device 101 may determine that the package 117 is authenticated; otherwise the package 117 is not authenticated.

In some examples, controller 220 and/or the device 101 may authenticate the package 117 by comparing an order number from the package order information 111 with a respective order number extracted from the images (e.g. including, but not limited to, extracting the order number from a barcode, and the like), the respective order number located at a label of the package 117 in the images. When a match therebetween occurs (e.g. which may be determined using confidence levels and threshold confidence levels, as describe above), the controller 220 and/or the device 101 may determine that the package 117 is authenticated; otherwise the package 117 is not authenticated.

In some examples, controller 220 and/or the device 101 may authenticate the package 117 by comparing an estimated delivery time, determined from the package order information 111, with an actual delivery time. For example, the estimated delivery time may be determined from a time that the package 117 was ordered with an estimated time period for the package 117 to be shipped and delivered add thereto; the actual delivery time may be determined from a time the package 117 was delivered, such a time determined by identifying the package 117 in the images. Times referred to herein may be determined using one or more clocks and/or time stamps on images (e.g. the camera device 103 may include a clock and time stamp images accordingly, and/or the device 101 may include a clock and determine a time for an image as the image is received at the device 101). When a match therebetween occurs (e.g. which may be determined using confidence levels and threshold confidence levels, as describe above), the controller 220 and/or the device 101 may determine that the package 117 is authenticated; otherwise the package 117 is not authenticated.

However, any comparison of information extracted from the images with the package order information 111 is within the scope of the present specification. For example, an identifier of the ordered item in the package order information 111 may be compared with an identifier of the ordered item from the images (e.g. as located on the label 125 and/or on the package 117).

While one confidence level is described with respect to each of the aforementioned examples, the controller 220 and/or the device 101 may further determine a cumulative and/or weighted confidence level for a match based on two or more of the aforementioned examples, using weights and the like. For example, a confidence level for a match between order numbers (e.g. which may be specific for the package 117) may be weighted higher than a confidence level for a match between names of the intended recipient 121 and/or identifiers of the delivery person 115 and/or a delivery service entity (e.g. as the intended recipient 121 may have ordered more than one package and/or the delivery person 115 and/or the delivery service entity may deliver more than one package). In these examples, a weighted confidence level may be compared to a weighted threshold confidence level to determine whether the package 117 is authenticated.

As a particular example, the controller 220 and/or the device 101 may determine a confidence level for a match between order numbers of 90%, which may be weighted at 0.8; the controller 220 and/or the device 101 may also determine a confidence level for a match between names of the intended recipient 121 of 70%, which may be weighted at 0.2. As such the controller 220 and/or the device 101 may determine a total weighted confidence level of a match of 86% (e.g. 90%×0.8+70%×0.2). The controller 220 and/or the device 101 may compare the total weighted confidence level of 86% to a given weighted threshold confidence level of 80%; as the weighted confidence level of 86% is higher than the given weighted threshold confidence level of 80%, the controller 220 and/or the device 101 determines that a match occurs.

In yet further examples, authentication may be assisted by comparing sensor data from other sensor devices (e.g. radar, LIDAR, etc.) provided with the camera device 103 to information of the package order information 111. For example, a size and/or shape of the package 117 may be determined from such sensor data and compared to an estimated size and/or shape of the package, determined from the package order information 111, as described above.

In response to authenticating the package (e.g. a “YES” decision at the block 306), at a block 308, the controller 220 and/or the device 101 implements one or more package receipt procedures 225 to control receipt of the package 117, the one or more package receipt procedures 225 implemented using one or more of: the camera device 103; the communication device 105 located at the controlled access point 113; and the access control mechanism 107 of the controlled access point 113.

Examples of the package receipt procedures 225 are next described. It is further understood that the package receipt procedures 225 are hardware-based. It is further understood that the package receipt procedures 225 may be implemented by the controller 220 and/or the device 101 implementing the instructions for the package receipt procedures 225 of the application 223.

In one example, a package receipt procedure 225 may comprise the controller 220 and/or the device 101 changing, using the access control mechanism 107, the controlled access point 113 from a first state that prevents (and/or discourages, for example by rendering of text, graphic, colors etc.) access therethrough to a second state that provides (and/or encourages, for example by rendering of text, graphic, colors etc.) access therethrough. For example, the controller 220 and/or the device 101 may open and/or unlock the controlled access point 113, via the access control mechanism 107, and/or may change a state of the display screen 105-1 from a red screen and/or stop text to a green screen and/or proceed text. In these examples, the controller 220 and/or the device 101 may further communicate with, and/or control the communication device 105 located at the controlled access point 113 to provide instructions to the delivery person 115 on where to deliver and/or place the package 117 through the controlled access point 113. For example, the display screen 105-1 may be controlled to visually render instructions (e.g. via text and/or graphics) to enter the controlled access point 113 to place the package 117 on a given shelf, and/or in a delivery area, and the like located through the controlled access point 113; alternatively, such instructions may be provided aurally via the speaker/microphone 115-2. Such a shelf and/or delivery area may be located in a secure area through the controlled access point 113 (such that the delivery person 115 cannot otherwise enter a building, and the like, at which the controlled access point 113 is located).

In another example, a package receipt procedure 225 may comprise the controller 220 and/or the device 101 notifying the respective communication device 119 of the intended recipient 121 that the delivery person 115 has arrived at the controlled access point 113 with the package 117. For example, the controller 220 and/or the device 101 may have access to a cell-phone number and/or email address and/or network address of the respective communication device 119 (e.g. as stored in an employee database in association with a name and/or employee number of the intended recipient 121, and which may be retrieved via a name, and the like, of the intended recipient 121 extracted from the information in the images from the camera device 103, and/or determined from the package order information 111). The controller 220 and/or the device 101 may transmit a message to the respective communication device 119 (e.g. using the cell-phone number and/or email address and/or network address), the message indicating that the package 117 associated with the package order information 111 has arrived at the controlled access point 113. Such a message may include information from the package order information 111 and/or information extracted from the images from the camera device 103.

Such a message may further include a request for the intended recipient 121 to come to the controlled access point 113 to receive the package 117. Such a message may further include a selectable option, such as electronic “YES” and “NO” soft-buttons, and the like, that allows the intended recipient 121 to indicate whether or not (e.g. selection of “YES” or “NO” respectively) they will come to the controlled access point 113 to receive the package 117.

Selection of the electronic “YES” soft-button (when present) may cause the respective communication device 119 to transmit a return message back to the device 101 indicating that the intended recipient 121 is on their way to the controlled access point 113 to receive the package 117.

In some examples, the controller 220 and/or the device 101 may determine an estimated time that the intended recipient 121 will arrive at the controlled access point 113 to receive the package 117, for example based on an electronic map, and the like, of a building and/or area that includes a location of the intended recipient 121 (e.g. such as an office, cubicle, and the like) and the controlled access point 113, and/or the controller 220 and/or the device 101 may determine the estimated time based on a location of the respective communication device 119 communicated to the device 101, by the respective communication device 119, in the return message. In these examples, controller 220 and/or the device 101 may further control the communication device 105 located at the controlled access point 113 to provide the estimated time to the delivery person 115, for example visually at the display screen 105-1 and/or aurally via the speaker/microphone 105-2. In some examples, the estimated time may be provided to the respective communication device 119 when the controller 220 and/or the device 101 notifies the respective communication device 119 of the intended recipient 121 that the delivery person 115 has arrived at the controlled access point 113 with the package 117

In examples where the selection of the electronic “NO” soft-button (when present) occurs, the controller 220 and/or the device 101 may implement another package receipt procedure 225, including, but not limited to, opening and/or unlocking the controlled access point 113 such that the delivery person 115 may leave the package 117 at a given area beyond the access point 113, and the like, as described above.

Furthermore, in examples where no electronic soft-buttons, and the like, are provided, the controller 220 and/or the device 101 may: notify the respective communication device 119 of the intended recipient 121 that the delivery person 115 has arrived at the controlled access point 113 with the package 117; determine the estimated time that the intended recipient 121 will arrive at the controlled access point 113 (e.g. assuming that the intended recipient 121 will leave their location upon receiving the notification); and control the communication device 105 to provide the estimated time to the delivery person 115.

It is understood that the estimated time that the intended recipient 121 will arrive at the controlled access point 113 includes, but is not limited to, a specific time and/or a time range and/or a relative time (e.g. a length of time estimated for the intended recipient 121 to arrive at the controlled access point 113), and the like. Furthermore, the controller 220 and/or the device 101 may update the estimated time based on progress of movement of the intended recipient 121 as tracked by the location of the respective communication device 119 (e.g. when the respective communication device 119 comprises a mobile communication device carried by the intended recipient 121).

In yet further examples, a package receipt procedure 225 may comprise the controller 220 and/or the device 101 controlling the communication device 105 located at the controlled access point to provide a respective image of the intended recipient 121. For example, while not depicted, the device 101 may have access to electronic employee records (e.g. stored at the memory 109 and/or an employee database, and the like) that include an electronic image of the intended recipient 121. The controller 220 and/or the device 101 may retrieve the electronic image of the intended recipient 121 (e.g. based on the name, and the like, in the information extracted from the images from the camera device 103 and/or the name in the package order information 111) from such a database and control the display screen 105-1 to render the electronic image of the intended recipient 121. Such a package receipt procedure 225 may be performed in conjunction with controlling the communication device 105 to provide an estimated time, that the intended recipient 121 will arrive at the controlled access point 113, to the delivery person 115, for example such that the delivery person 115 may verify the intended recipient 121 when they arrive at the controlled access point 113.

In yet further examples, a package receipt procedure 225 may comprise the controller 220 and/or the device 101 generating, using the images from the camera device 103, that include the package 117 being delivered, a chain-of-custody record; and storing, at a memory, the chain-of-custody record (e.g. the chain-of-custody record may be stored at the memory 109 and/or another memory that stores chain-of-custody records, including, but not limited to, a memory accessible to the accounts payable computing device 123, and the like). For example, the images from the camera device 103, that include the package 117 being delivered, stored in the chain-of-custody record may include, but are not limited to, an image of the package 117 being handled by the delivery person 115, and an image of the intended recipient 121 taking receipt of the package 117 at the controlled access point 113.

In yet further examples, a package receipt procedure 225 may comprise the controller 220 and/or the device 101 notifying the accounts payable computing device 123 that the package 117 has been delivered, for example such that the accounts payable computing device 123 may release funds and/pay an invoice for the package 117. Such notifying the accounts payable computing device 123 may occur via any suitable electronic messaging and/or database procedures (e.g. an accounts payable database may be updated to indicate that the package 117, associated with the order number in the package order information 111, has been delivered). In some examples, such notifying may include, but is not limited to, transmitting the aforementioned chain-of-custody record to the accounts payable computing device 123.

In yet further examples, a package receipt procedure 225 may comprise the controller 220 and/or the device 101 determining, based on the package order information 111, that the package 117 is being delivered to an incorrect location, the package order information 111 further indicating a correct location for delivery of the package. For example, the package 117 may be authenticated on the basis of an order number in the images from the camera device 103 matching an order number of the package order information 111; however, the intended recipient 121 may be geographically located at an address different from an address in the images from the camera device 103, and/or the delivery person 115 may have attempted to deliver the package 117 to the intended recipient 121 at an address that is different from an address in the images (e.g. at another building and/or location of an enterprise of which the intended recipient 121 is an employee). In these examples, the controller 220 and/or the device 101 may control the communication device 105 located at the controlled access point 113 to provide the correct location to the delivery person 115. For example an actual an address of the correct location (e.g. an address of a building where the intended recipient 121 works) may be extracted from electronic employee records, similar to as described above respect to an image of the intended recipient 121.

In yet further examples, a package receipt procedure 225 may comprise the controller 220 and/or the device 101 determining, based on the images from the camera device 103, that the package 117 is damaged (e.g. using a machine learning algorithm and/or an object recognition engine trained to identify damaged packages). In some of these examples, the controller 220 and/or the device 101 may control the communication device 105 to transmit the images that include the package 117 as damaged to the respective communication device 119 of the intended recipient 121, for example, to notify the intended recipient 121 that the package 117 is being delivered in a damaged state; in some examples, the intended recipient 121 may accept or refuse delivery of the package 117 as damaged, for example via a graphic user interface, and the like, provided with the images that include the package 117 as damaged. Alternatively (and/or in addition to notifying the intended recipient 121 that the package 117 is being delivered in a damaged state), the controller 220 and/or the device 101 may store, at a memory (e.g. the memory 109 and/or a chain-of-custody memory), the images that include the package 117 as damaged; and/or the controller 220 and/or the device 101 may store, at the memory, the images that include the package 117 as damaged in a chain-of-custody record. In examples where the intended recipient 121 refuses delivery of the package 117 (e.g. due to damage), a notification of refusal may be provided at the communication device 105, and such refusal may also be stored in a chain-of-custody record.

However, it is understood that any suitable combination of the above described package receipt procedures 225 may be implemented and/or a subset of the package receipt procedures 225 may be implemented; for example, the device 101 may notify the intended recipient 121 of the package 117, notify the accounts payable computing device 123 of the package 117 and/or generate a chain-of-custody record, and the like.

Alternatively, when a given package receipt procedure 225 is not available for implementation, other package receipt procedures 225 may be implemented. For example, as described above, in response to the intended recipient 121 indicating via selection of an electronic soft-button “NO” that they are not available to receive the package 117, one or more other package receipt procedures 225 may be implemented (e.g. other than estimating a time for the intended recipient 121 to arrive at the controlled access point 113). The device 101 may determine that the intended recipient 121 is not available to receive the package 117 using other processes; for example, the device 101 may have access to presence data indicating that the intended recipient 121 is available or not available.

It is further understood that other suitable hardware-based package receipt procedures 225 are within the scope of the present specification. For example, when the intended recipient 121 is not available the controller 220 and/or the device 101 may notify a respective communication device of a mailroom employee (e.g. a mailroom enterprise receiver) to come to the controlled access point 113 to receive the package 117, and other hardware-based package receipt procedures 225 may be implemented as described above.

Returning briefly to the block 306, in response to not authenticating the package (e.g. a “NO” decision at the block 306), at a block 310, the controller 220 and/or the device 101 may implement one or more reject package receipt procedures to reject receipt of the package 117. For example, when authentication fails at the block 306 (e.g. a confidence level is determined to be below a threshold confidence level, as described above), the controller 220 and/or the device 101 may control the communication device 105 to provide a visual and/or aural notification that the delivery person 115 is attempting to deliver the package 117 for which there no record and/or to a person who is unknown to the device 101, and the like. Alternatively, the controller 220 and/or the device 101 may notify a respective communication device of a mailroom employee (e.g. a mailroom enterprise receiver) to come to the controlled access point 113 to speak with the delivery person 115 and/or to inspect the package 117 and manually determine whether to receive the package 117.

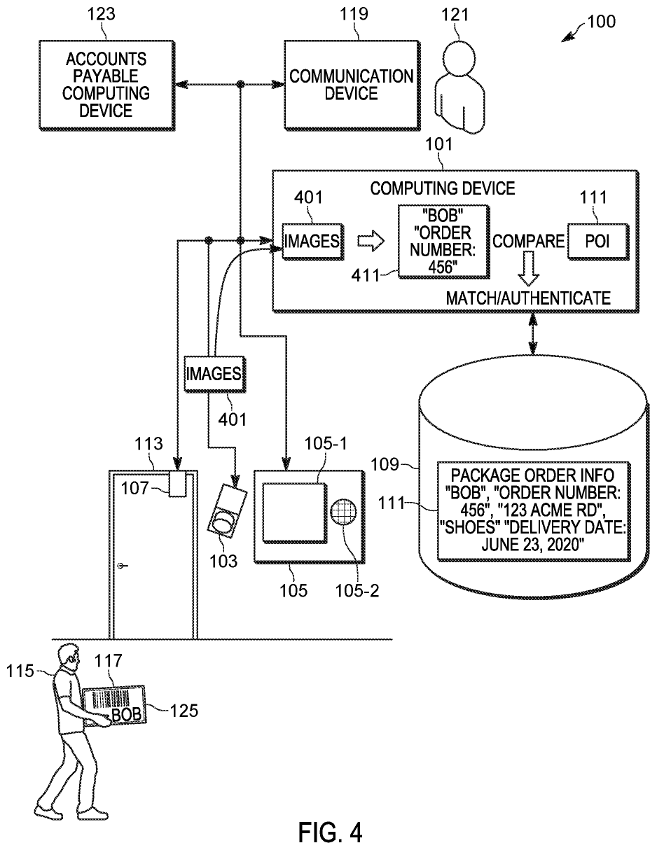

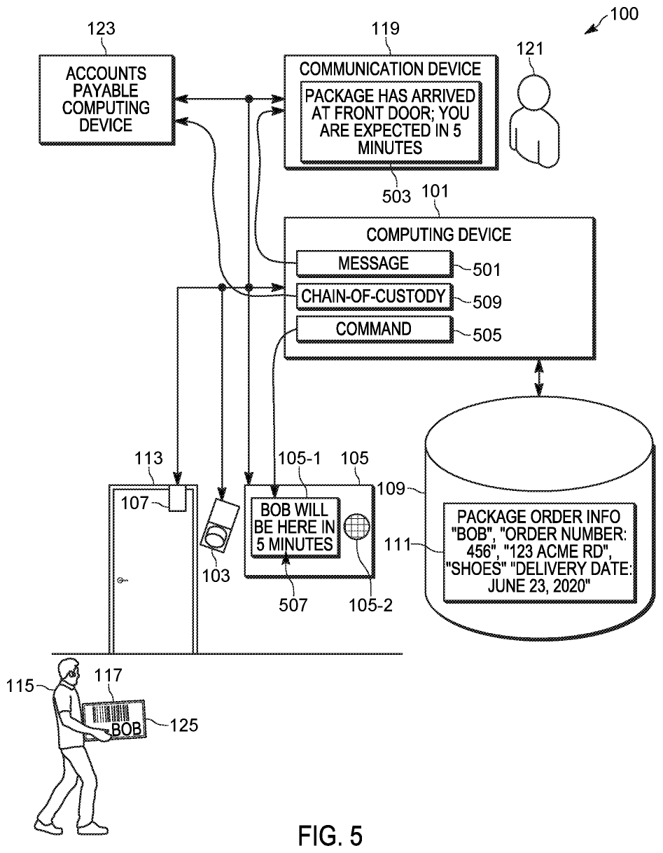

Examples of aspects of the method 300 will next be described with respect to FIG. 4 and FIG. 5, which are substantially similar to FIG. 1, with like components having like numbers.

With reference to FIG. 4, the device 101 is receiving images 401 from the camera device 103, that are understood to include the delivery person 115 and/or the package 117. As such, the device 101 determines (e.g. at the block 302 of the method 300) that the delivery person 115 has arrived at the controlled access point 113 with the package 117. As depicted, the device 101 extracts information 411 from the images 401, such as the name “Bob” on the label 125 and an order number “456” extracted from the barcode, and the like, on the label 125. The device 101 compares (e.g. at the block 304 of the method 300), the information 411 to the package order information 111 (e.g. retrieved from the memory 109 using a database lookup, and the like, using the name “Bob” and/or the order number “456” from the information 411) to determine that the information 411 matches the package order information 111. As such, the device 101 authenticates the package 117 (e.g. a “YES” decision at the block 306 of the method 300), as indicated by the text “Match/Authenticate” in FIG. 4.

With reference to FIG. 5, as the package 117 has been authenticated by the device 101, the device 101 implements one or more of the hardware-based package receipt procedures 225 (e.g. at the block 308 of the method 300). For example, as depicted, the device 101 transmits a message 501 to the respective communication device 119 that includes text 503 indicating that the package 117 has arrived at the controlled access point 113 (e.g. the “Package Has Arrived At Front Door”), and which also includes an estimated relative time for the intended recipient 121 to arrive to travel to the controlled access point 113 (e.g. “You Are Expected In 5 Minutes”). The text 503 may be visually provided at a display screen of the respective communication device 119 and/or aurally provided at a speaker of the respective communication device 119.

As depicted, the device 101 further controls the communication device 105 to provide the estimated time that the intended recipient 121 will arrive at the controlled access point 113 to receive the package 117, for example by transmitting instructions 505 to the communication device 105 to cause the display screen 105-1 to visually provide text that includes the estimated time (e.g. and a name of the intended recipient 121, for example, as depicted, “Bob Will Be Here In 5 Minutes”). The text 507 may alternatively be aurally provided via the speaker/microphone 105-2.

Additionally, or alternatively, the device 101 may initiate a communication session between the devices 105, 119 (e.g. a voice call and/or a video call).

As depicted, the device 101 further generates a chain-of-custody record 509 that is transmitted to the accounts payable computing device 123 as a notification to the accounts payable computing device 123 that the package 117 has been delivered, however the chain-of-custody record 509 may not be generated and/or transmitted until images from the camera device 103 show the intended recipient 121 receiving the package 117 at the controlled access point 113. Furthermore, a notification to the accounts payable computing device 123 that the package 117 has been delivered may be provided in a format other than the chain-of-custody record 509.

Hence, one or more hardware-based package receipt procedures 225 may be implemented in response to the package 117 being authenticated, which may reduce time for the intended recipient 121 to receive the package 117 and/or reduce time for the accounts payable computing device 123 to be notified of delivery of the package 117, and the like, for example as compared to when the package 117 is manually received by a mailroom enterprise receiver (e.g. in response to the delivery person 115 using an intercom and/or manually knocking on the controlled access point 113 to get the attention of the mailroom enterprise receiver). Furthermore, such one or more hardware-based package receipt procedures 225 may result in improved accuracy of delivery, accuracy of records associated with the delivery, including but not limited to chain-of-custody records, improved and/or speedier invoicing, and the like.

As should be apparent from the detailed description above, the operations and functions of the computing device are sufficiently complex as to require their implementation on a computer system, and cannot be performed, as a practical matter, in the human mind. Computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any component(s) that may cause any benefit, advantage, or solution to occur or become more pronounced are not to be construed as a critical, required, or essential features or components of any or all the claims. The invention is defined solely by the appended claims including any amendments made during the pendency of this application and all equivalents of those claims as issued.

In this document, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one . . . ” and “one or more . . . ” language.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of components does not include only those components but may include other components not expressly listed or inherent to such process, method, article, or apparatus. A component proceeded by “comprises . . . a”, “has . . . a”, “includes . . . a”, “contains . . . a” does not, without more constraints, preclude the existence of additional identical components in the process, method, article, or apparatus that comprises, has, includes, contains the component. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method comprising:
determining, at a computing device, using images from a camera device communicatively coupled to the computing device and configured to image a region adjacent a controlled access point, that a delivery person has arrived at the controlled access point with a package;
authenticating, at the computing device, the package by comparing information extracted from the images with package order information indicative of one or more of the package and an intended recipient of the package, the images including a printed label of the package, the information extracted from the images including, from the printed label, one or more of: a name of the intended recipient; an address of the intended recipient, an identifier of an ordered item, and an order number, the authenticating comprises one or more of:
comparing the information from the printed label with the package order information;
comparing an estimated size of the package, determined from the package order information, with a size of the package determined from the image; and
comparing an estimated delivery time, determined from the package order information, with an actual devilery time, determined from a time that the package was ordered and a time the package was delivered determined by identifying the package in the images; and
in response to authenticating the package, implementing, at the computing device, one or more package receipt procedures to control receipt of the package, the one or more package receipt procedures implemented using one or more of: the camera device; a communication device located at the controlled access point; and an access control mechanism of the controlled access point,
the controlled access point comprising one or more of a door, a double door, a gate, a portal, an entrance, a turnstile, an exit, through which passage is electronically controlled via the access control mechanism, and
the one or more package receipt procedures comprising the computing device electronically controlling the access control mechanism to one or more of electronically unlock and electronically open the controlled access point.

2. The method of claim 1, wherein authenticating the package, by comparing the package order information with the information extracted from the images, further comprises one or more of:
comparing a respective image of a predetermined delivery person from the package order information with a respective image of the delivery person extracted from the images; and
comparing an identifier of a delivery service entity from the package order information with a respective identifier extracted from the images, the respective identifier located at one or more of the package, a uniform of the delivery person and a vehicle of the delivery person located in the images.

3. The method of claim 1, wherein the one or more package receipt procedures further comprises:
establishing a two-way media session between the communication device located at the controlled access point, and a respective communication device of the intended recipient.

4. The method of claim 1, wherein the one or more package receipt procedures further comprises:
controlling the communication device located at the controlled access point to provide instructions to the delivery person on where to place the package through the controlled access point.

5. The method of claim 1, wherein the one or more package receipt procedures further comprises:
notifying a respective communication device of the intended recipient that the delivery person has arrived at the controlled access point with the package;
determining an estimated time that the intended recipient will arrive at the controlled access point to receive the package; and
controlling the communication device located at the controlled access point to provide the estimated time to the delivery person.

6. The method of claim 1, wherein the one or more package receipt procedures further comprises:
controlling the communication device located at the controlled access point to provide a respective image of the intended recipient.

7. The method of claim 1, wherein the one or more package receipt procedures further comprises:
generating, using the images that include the package being delivered, a chain-of-custody record; and
storing, at a memory, the chain-of-custody record.

8. The method of claim 1, wherein the one or more package receipt procedures further comprises:
notifying an accounts payable computing device that the package has been delivered.

9. The method of claim 1, wherein the one or more package receipt procedures further comprises:
determining, based on the package order information, that the package is being delivered to an incorrect location, the package order information further indicating a correct location for delivery of the package; and
controlling the communication device located at the controlled access point to provide the correct location to the delivery person.

10. The method of claim 1, wherein the one or more package receipt procedures further comprises:
determining, based on the images, that the package is damaged; and one or more of:
controlling the communication device to transmit the images that include the package as damaged to a respective communication device of the intended recipient;
storing, at a memory, the images that include the package as damaged; and
storing, at the memory, the images that include the package as damaged in a chain-of-custody record.

11. A device comprising:
a communication unit configured to communicate with a camera device configured to image a region adjacent a controlled access point; and
a controller communicatively coupled to the camera device via the communication unit, the controller configured to:
determine, using images from the camera device, that a delivery person has arrived at the controlled access point with a package;
authenticate the package by comparing information extracted from the images with package order information indicative of one or more of the package and an intended recipient of the package, images including a printed label of the package, the information extracted from the package images including, from the printed label, one or more of: a name of the intended recipient; an authenticating comprising one or more of:
comparing the information from the printed label with the package order information;
comparing an estimated size of the package, determined from the package order information, with a size of the package determined from the images; and
comparing an estimated delivery time, determined from the package order information, with an actual delivery time, determined from a time that the package was ordered and a time the package was delivered determined by identifying the package in the images; and
in response to authenticating the package, implement one or more package receipt procedures to control receipt of the package, the one or more package receipt procedures implemented using one or more of: the camera device; a communication device located at the controlled access point; and an access control mechanism of the controlled access point,
the controlled access point comprising one or more of a door, a double door, a gate, a portal, an entrance, a turnstile, an exit, through which passage is electronically controlled via the access control mechanism, and
the one or more package receipt procedures comprising the controller electronically controlling the access control mechanism to one or more of electronically unlock and electronically open the controlled access point.

12. The device of claim 11, wherein the controller is further configured to authenticate the package, by comparing the package order information with information extracted from the images, by one or more of:
comparing a respective image of a predetermined delivery person from the package order information with a respective image of the delivery person extracted from the images; and
comparing an identifier of a delivery service entity from the package order information with a respective identifier extracted from the images, the respective identifier located at one or more of the package, a uniform of the delivery person and a vehicle of the delivery person located in the images.

13. The device of claim 11, wherein the one or more package receipt procedures further comprises:
establishing a two-way media session between the communication device located at the controlled access point, and a respective communication device of the intended recipient.

14. The device of claim 11, wherein the one or more package receipt procedures further comprises:
controlling the communication device located at the controlled access point to provide instructions to the delivery person on where to place the package through the controlled access point.

15. The device of claim 11, wherein the one or more package receipt procedures further comprises:
notifying a respective communication device of the intended recipient that the delivery person has arrived at the controlled access point with the package;
determining an estimated time that the intended recipient will arrive at the controlled access point to receive the package; and
controlling the communication device located at the controlled access point to provide the estimated time to the delivery person.

16. The device of claim 11, wherein the one or more package receipt procedures further comprises:
controlling the communication device located at the controlled access point to provide a respective image of the intended recipient.

17. The device of claim 11, wherein the one or more package receipt procedures further comprises:
generating, using the images that include the package being delivered, a chain-of-custody record; and
storing, at a memory, the chain-of-custody record.

18. The device of claim 11, wherein the one or more package receipt procedures further comprises:
notifying an accounts payable computing device that the package has been delivered.

19. The device of claim 11, wherein the one or more package receipt procedures further comprises:
determining, based on the package order information, that the package is being delivered to an incorrect location, the package order information further indicating a correct location for delivery of the package; and
controlling the communication device located at the controlled access point to provide the correct location to the delivery person.

20. The device of claim 11, wherein the one or more package receipt procedures further comprises:
determining, based on the images, that the package is damaged; and one or more of:
controlling the communication device to transmit the images that include the package as damaged to a respective communication device of the intended recipient;
storing, at a memory, the images that include the package as damaged; and
storing, at the memory, the images that include the package as damaged in a chain-of-custody record.
